(19) United States
(12) Patent Application Publication
(10) Pub. No.: US 2022/0226955 A1
(43) Pub. Date: Jul. 21, 2022

(54) ACCESSORY ATTACHMENT FOR RANDOM-ORBITAL SANDER

(71) Applicant: 3M INNOVATIVE PROPERTIES COMPANY, St. Paul, MN (US)

(72) Inventor: Erin D. Spring, Darien Center, NY (US)

(21) Appl. No.: 17/613,317

(22) PCT Filed: May 14, 2020
(86) PCT No.: PCT/IB2020/054583

§ 371 Date: Nov. 22, 2021

Related U.S. Application Data
(60) Provisional application No. 62/851,724, filed on May 23, 2019.

(51) Int. Cl. B24B 23/03; B24D 9/08

(52) U.S. Cl. CPC B24B 23/03; B24D 9/08

(57) ABSTRACT

An assembly for attachment of an accessory to a random-orbital sander is disclosed comprising a drive spindle, a support plate, one or more drive members located on and protruding from either of both of the drive spindle and/or the support plate, and one or more drive sockets corresponding to the one or more drive members. The one or more drive sockets are located on either or both of the drive spindle and/or the support plate. An attachment member adapted to protrude through an attachment aperture to fix the support plate and drive spindle against axial movement. One or more of the drive members seats within a corresponding drive socket to fix the drive spindle and support plate against relative rotational movement. One or more tuning members are positioned between the drive spindle and the support plate to space the support plate from the drive spindle a predetermined distance. A method of assembling a corresponding accessory to a random orbital sander and a method of balancing vibration in a random orbital sander by means of one or more tuning members are also disclosed.

### BACKGROUND

Rotary tools such as random orbital sanders (ROS) are known for use in industrial surface modification applications. They are used with, for example, coated abrasive discs to remove and refine many substrates (e.g., wood, metal, plastic, & paint). The offset or orbit of a random-orbital sander causes a vibration which is reduced by a counter weight built into a motor shaft balancer. The shaft balancer is designed to counter balance the weight and center of gravity of the backup dad (BUP) that is required to support the abrasive disc, and can vary depending on, among other things, the plane upon which the mass of the backup pad will lie in use. Design methodology for shaft balancers for countering vibration in rotating masses and in orbital sanders is generally known, as described, for example, in Mechanisms and Dynamics of Machinery, 4^{th} Edition, (Chapter 10, “Balance of Machinery”), in the Machinery's Handbook, 26^{th} Edition (pages 170-171, “Counterbalancing Masses Located in Two or More Planes”), and in U.S. Pat. No. 6,206,771 to Lehman.

A 5 inch diameter BUP for an industrial grade random orbital sander typically weighs around 100 grams, while a 6 inch diameter version typically weighs around 130 grams. BUPs for industrial random-orbital sanders are typically mounted to the tool with a 5/16-24 threaded fastener. The tool typically incorporates a spindle having a female 5/16-24 thread, while the BUP has a permanently attached male 5/16-24 threaded stud. In current BUP designs, the 5/16-24 fastener is riveted to an epoxy glass support plate, and a two-part urethane foam pad is molded to the plate in a shape preferred for the desired applications. Due to imbalances and non-concentricity introduced by the riveting process, the produced BUPs may vary in weight and balance, which can induce undesirable vibration, negatively affecting operator comfort and safety. The conventional fastening hardware also typically results in greater mass of the BUP, which means that a greater mass that must be counter-balanced by the shaft balancer in the ROS.

In current designs, the axial position of the fastening hardware (and therefore the backup pad itself) is fixed with respect to the rotary shaft of the tool by virtue of the design of the tool from the manufacturer. Although manufacturers may provide a fiber washer to be sandwiched in between the backup pad and the tool, such fiber washers are designed merely to mitigate heat transfer to prevent seizing of the connected components that might cause the backup pad to fuse to the rotary shaft (and therefore be difficult to unscrew) and to reduce heat transfer into other components of the tool.

Moreover, for such conventional BUPs, the 5/16-24 fastener is tightened against (or loosened from) a ROS by means of a thin wrench which must be carefully inserted into the narrow space between the BUP and the ROS to hold the spindle against rotation while the threaded stud of the BUP is unscrewed from the spindle. Due to the narrow space and the resulting limited visibility, it can be difficult to insert the wrench, and/or to properly align the wrench with corresponding flats on the spindle.

There is a need for improved industrial ROS BUP and BUP attachment designs.

### SUMMARY OF THE INVENTION

The present disclosure relates to BUP (or “backup pad”) and BUP attachment designs that can, for example, (i) reduce or eliminate material and hardware that was previously required to mount a BUP to an industrial random-orbital sander (“ROS”); (ii) allow for weight and vibration to be further reduced or minimized; (iii) extend tool life; and (iv) allow for easier attachment, removal, and replacement of a BUP from the ROS.

Rather than incorporating a fastener riveted to an epoxy glass support plate and a two-part urethane foam pad molded to the plate, the improved BUP incorporates a support plate that can be precisely machined to tight tolerances, whereby a compressible pad and accessory attachment components (e.g., hooks or vinyl facing material for attachment of an abrasive disc) can be molded to the support plate. Thus, the riveted fastener can be eliminated from the BUP.

A drive spindle is provided that secures to a rotary portion on the random-orbital sander. One or both of the support plate or the drive spindle may comprise drive sockets designed to receive corresponding drive members protruding from the other of the two parts. The drive members are inserted into the drive sockets. The support plate further comprises a center hole through which a securing member is used to secure the BUP to the drive spindle. The BUP weight is controlled by the support plate material, diameter, thickness, number and size of holes in it, and the composition, shape, and size of the compressible material of the pad. Once the optimum BUP weight and shape along with the desired abrasive (which adds variable mass depending on the abrasive disc selected) are defined, the random-orbital sander shaft balancer of the random-orbital sander, along with the proper axial positioning of the BUP with respect to the drive spindle, can be optimized. The combination of a balanced BUP and shaft balancer can thus be designed to keep vibration of the tool to the lowest level possible.

According to the present disclosure, one or more tuning members are employed to establish the proper axial spacing of the BUP with respect to the rotary portion of the random-orbital sander. The tuning member(s) may be placed between the drive spindle and the support plate and may be configured with one or more tuning apertures to allow the drive member(s) to pass through into the drive socket(s). The tuning member(s) can allow the mass of a particular BUP (and in turn the connected abrasive) to be placed in the correct axial location in order to fine tune vibration performance. A single tuning member may be used, or a stack of two or more tuning members may be used to achieve the desired spacing.

In addition to the above benefits, the presently disclosed designs can allow for easier attachment, removal, and replacement of BUPs from a ROS. This is because, unlike the conventional 5/16-24 threaded design of the above-described prior art industrial ROS, the described attachment member(s) are accessible from the open side of the BUP (i.e., the side facing away from the random-orbital sander). Therefore, an operator can easily see and access the securing member and engage a tool as necessary to tighten or loosen it to or from the drive spindle, thereby avoiding the need to insert a wrench into narrow space between the BUP and the tool.

Exemplary embodiments according to the present disclosure include, but are not limited to, the embodiments listed below, which may or may not be numbered for convenience. Several additional embodiments, not specifically enumerated in this section, are disclosed within the accompanying detailed description.

### Exemplary Embodiments

1. An assembly for attachment of an accessory to a random-orbital sander comprising a drive spindle comprising a longitudinal axis, a tool attachment end adapted for attaching the drive spindle to a rotary portion of the random-orbital sander, and an accessory attachment end for attaching the accessory to the drive spindle;

a support plate comprising an attachment aperture connecting a tool side and an accessory side, the attachment aperture comprising an aperture axis adapted to align with the longitudinal axis of the drive spindle;

one or more drive members located on and protruding from either of both of the drive spindle along the longitudinal axis and/or the support plate along the aperture axis;

one or more drive sockets corresponding to the one or more drive members, the one or more drive sockets located on and recessed within either or both of the drive spindle along the longitudinal axis and/or the support plate along the aperture axis;

one or more tuning members positioned between the accessory attachment end of the drive spindle and the tool side of the support plate to space the support plate from the drive spindle a predetermined distance X along the longitudinal axis; and

an attachment member adapted to protrude through the attachment aperture to retain the support plate to the accessory attachment end of the drive spindle with the one or more tuning members disposed therebetween;

wherein, upon assembly,

one the tool side of the support plate, one or more of the drive members seats within a corresponding drive socket to fix the drive spindle and support plate against relative rotational movement about the longitudinal axis; and

the attachment member protrudes through the attachment aperture from the accessory side of the support plate and is secured to the accessory attachment end of the drive spindle to fix the support plate and drive spindle against axial movement along the longitudinal axis.

2. The assembly of Embodiment 1 wherein the drive spindle comprises two or more drive members, and the support plate comprises two or more corresponding drive sockets. The assembly of Embodiment 1 wherein the support plate comprises two or more drive members, and the drive spindle comprises two or more corresponding drive sockets.

3. The assembly of any of Embodiments 1-2 wherein at least one drive member comprises a pin, and the corresponding drive socket comprises a hole to receive the pin.

4. The assembly of any of Embodiments 1-3 wherein at least one drive member is integral with either the drive spindle or the support plate.

5. The assembly of any of Embodiments 1-4 wherein at least one drive member is formed from a separate piece that is bonded to either the drive spindle or the support plate.

6. The assembly of Embodiment 5 wherein the at least one drive member is bonded to either the drive spindle or the support plate by one of a friction fit, adhesive, thread, snap fit, or weld.

7. The assembly of any of Embodiments 1-6 wherein the attachment member is adapted to threadably attach to the accessory attachment end of the drive spindle.

8. The assembly of any of Embodiments 1-7 further comprising a compressible member attached to the accessory side of the support plate, the compressible member comprising an access aperture to permit access to the attachment member from the accessory side.

9. The assembly of any of Embodiments 1-8 wherein the one or more tuning members comprises one or more tuning apertures corresponding to the one or more drive members, wherein the one or more drive members is adapted to pass through the one or more tuning apertures.

10. The assembly of any of Embodiments 1-9 comprising two or more tuning members positioned in a stack between the accessory attachment end of the drive spindle and the tool side of the support plate.

11. An accessory for attachment to a random-orbital sander comprising

a support plate comprising an attachment aperture connecting a tool side and an accessory side, the attachment aperture comprising an aperture axis;

one or more

drive members protruding from the tool side of the support plate along the aperture axis; or

drive sockets recessed within the tool side of the support plate along the aperture axis;

wherein the one or more drive members and/or drive sockets are positioned radially outwardly of the aperture axis;

one or more tuning members adapted to be positioned on the tool side of the support plate; and

a compressible member attached to the accessory side of the support plate, the compressible member comprising an access aperture to permit access to the attachment aperture from the accessory side.

12. The accessory of Embodiment 11 wherein the support plate comprises at least two drive sockets recessed within the tool side.

13. The accessory of any of Embodiments 11-12 wherein the support plate comprises at least two drive members protruding from the tool side.

14. The accessory of any of Embodiments 12-13 wherein the one or more tuning members comprises one or more tuning apertures corresponding to either of the one or more drive members or drive sockets, wherein the one or more drive members or drive sockets is aligned with the one or more tuning apertures.

15. The assembly of any of Embodiments 13-14 comprising two or more tuning members positioned in a stack between the accessory attachment end of the drive spindle and the tool side of the support plate.

16. A drive spindle assembly for attachment of an accessory to a random-orbital sander comprising

a longitudinal axis, a tool attachment end adapted for attaching the drive spindle to a rotary portion of the random-orbital sander, and an accessory attachment end for attaching the accessory to the drive spindle;

one or more

drive members protruding from the accessory attachment end of the drive spindle along the longitudinal axis; or

drive sockets recessed within the accessory attachment end of the drive spindle along the longitudinal axis;

wherein the one or more drive members and/or drive sockets are positioned radially outwardly of the longitudinal axis;

an attachment member adapted to retain the accessory to the accessory attachment end of the drive spindle; and

one or more tuning members adapted to be positioned on the accessory attachment end of the drive spindle.

17. The drive spindle assembly of Embodiment 16 comprising at least two drive sockets recessed within the accessory attachment end.

18. The drive spindle assembly of any of Embodiments 16-17 comprising at least two drive members protruding from the accessory attachment end.

19. The drive spindle assembly of any of Embodiments 16-18 wherein the one or more tuning members comprises one or more tuning apertures corresponding to either of the one or more drive members or drive sockets, wherein the one or more drive members or drive sockets is aligned with the one or more tuning apertures.

20. A random orbital sander comprising

a rotary portion; and

an assembly according to any of Embodiments 1-10 adapted to connect to the rotary portion.

21. A random orbital sander comprising

a rotary portion; and

a drive spindle assembly according to any of Embodiments 16-19 adapted to connect to the rotary portion.

22. A method of assembling an accessory to a random orbital sander comprising

providing an assembly according to any of Embodiments 1-19;

aligning the longitudinal axis with the central axis;

aligning a drive member with a drive socket;

positioning the tool side of the support plate against the accessory attachment end of the drive spindle with the one or more tuning member disposed therebetween, thereby seating the drive member into the drive socket to fix the drive spindle and support plate against relative rotational movement about the longitudinal axis and spacing the support plate a predetermined distance X from the accessory attachment end of the drive spindle along the longitudinal axis;

securing the attachment member from the accessory side of the support plate to the accessory attachment end of the drive spindle to fix the support plate and drive spindle against axial movement along the longitudinal axis.

23. The method of Embodiment 22 comprising, prior to aligning the longitudinal axis with the central axis, affixing the tool end of the drive spindle to a rotary portion of the random-orbital sander.

24. The method of any of Embodiments 22-23 wherein positioning the tool side of the support plate against the accessory attachment end of the drive spindle comprises positioning a tuning member between the accessory attachment end of the drive spindle and the tool side of the support plate.

25. A method of balancing vibration in a random orbital sander comprising

installing one or more tuning members between a drive spindle of the random orbital sander and a support plate of a cooperating accessory, the one or more tuning members having an overall thickness that results in a corresponding axial spacing X between the drive spindle and the support plate, wherein the overall thickness of the one or more tuning members results in reduced measured vibration exposure in operation compared to an axial spacing of zero, wherein vibration exposure is measured according to the ISO 28972 test method;

wherein one of the drive spindle or the support plate comprises one more drive members, and the other of the drive spindle or the support plate comprises one or more corresponding drive sockets, and wherein the one or more tuning members comprises one or more tuning apertures corresponding to the one or more drive members such that the one or more drive members passes through the one or more tuning apertures to permit variable axial spacing between the drive spindle and the support plate.

26. The method of Embodiment 25 wherein the reduction in measured vibration exposure is greater than 10 percent.

27. The method of either of Embodiments 25 or 26, wherein the cooperating accessory is a backup pad without an abrasive disc installed thereon.

The words “preferred” and “preferably” refer to embodiments described herein that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the terms “comprises” and variations thereof do not have a limiting meaning where these terms appear in the accompanying description. Moreover, “a,” “an,” “the,” “at least one,” and “one or more” are used interchangeably herein.

Relative terms such as left, right, forward, rearward, top, bottom, side, upper, lower, horizontal, vertical, and the like may be used herein and, if so, are from the perspective observed in the particular figure. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

The above summary is not intended to describe each embodiment or every implementation of the subject matter described herein. Rather, a more complete understanding of the invention will become apparent and appreciated by reference to the following Description of Illustrative Embodiments and claims in view of the accompanying figures of the drawing.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIGS. 1 and 2 depict exemplary random-orbital sanders;

FIG. 3 depicts an exemplary accessory along with an exemplary accessory for attachment of the accessory to a random-orbital sander;

FIG. 4 is a cross-section taken at 4-4 of FIG. 3;

FIG. 5 depicts an exemplary accessory according to the present disclosure;

FIG. 6 is a cross-section taken at 6-6 of FIG. 5;

FIGS. 7 and 8 depict an exemplary drive spindle according to the present disclosure;

FIG. 9 is a cross-sectional view taken along the same cut as FIG. 6 of an exemplary accessory including a drive spindle;

FIG. 10 depicts a method according to the present disclosure; FIG. 11 depicts a prior art accessory with fastening hardware;

FIG. 12 is a cross-section taken at 12-12 of FIG. 11 with prior art compressible member and abrasive removed; and

FIG. 13 depicts the prior art fastening hardware shown in FIGS. 11 and 12 in isolated form.

### DETAILED DESCRIPTION

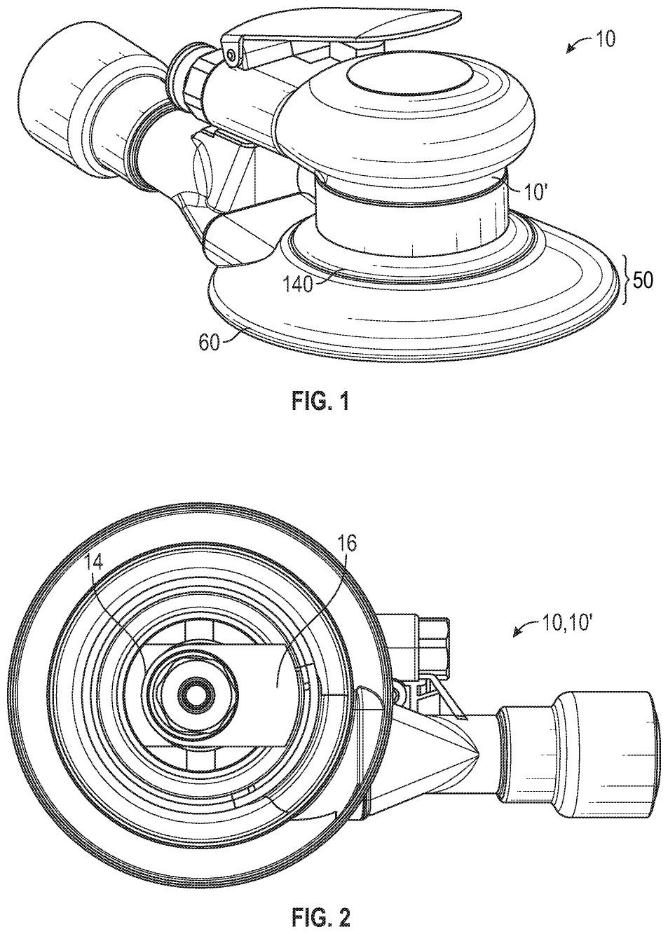

Referring to FIG. 1, a random-orbital sander (“ROS”) 10 is depicted. Although the model depicted is a pneumatically powered tool, the tool may electrically or otherwise powered within the scope of the present disclosure. The depicted random-orbital sander is intended to be used handheld, but robot-mounted or cart-mounted (e.g., floor sanders) are also within the scope of the present disclosure. Although the presently disclosed accessory attachment assembly may be used for other types of rotary tools, it can be especially beneficial for industrial random-orbital sanders due to the opportunity to reduce vibration that is inherently induced by the random orbit of the rotary portion and attached accessory 50. Moreover, the concepts disclosed herein can be especially beneficial for tools that are intended to be handheld, as a reduction in hand-arm vibration can be beneficial to human operators. However, even when the presently disclosed concepts are employed in non-handheld applications, improvements can nevertheless be recognized over known tools due to the relative ease of attaching and removing an accessory 50 from the tool, and due to potential improvements in tool life as described herein.

As can be seen, the random-orbital sander 10 has an accessory 50 attached to its working portion. The accessory 50 is driven by a rotary portion 14 (not visible in FIG. 1) and comprises a compressible member 60 attached to a support plate 140. The compressible member may be made of a resilient material such as foam or rubber of varying stiffness for the desired application, as known in the art.

Referring to FIG. 2, the rotary portion 14 is fitted with a shaft balancer 16. The shaft balancer 16 provides a counterweight to partially or mostly offset forces created by the random orbit of the rotary portion. The material, shape, size, and position of the shaft balancer 16 may be selected to balance rotary portions and accessories of varying configurations.

Once the configuration of the shaft balancer 16 is selected for a certain configuration, it cannot be readily changed in typical tools. Therefore, the factory-set balance can be disrupted if the operator chooses to install different accessories or combinations of accessories. For example, an operator may wish to use a backup pad of differing size, weight, or thickness than the configuration to tool was optimized for. Moreover, different types of abrasive discs the operator uses may have different masses or thicknesses. Furthermore, it is known that the application of force on the abrasive while abrading can further alter the rotary balance of the tool, such that different levels of vibration may be experienced by the operator depending on the level of force required for the particular application. If a combination of accessories and applied force results in higher than desirable levels of vibration, such vibration can not only result in discomfort for operators, but can decrease the overall life of the tool. This is because excess heat and vibration can cause premature wear in bearings and other components that support the rotating shaft. In addition to the above drawbacks, the finish on a workpiece attainable by the operator can be negatively affected due to excess vibration causing a reduced ability to control the tool while grinding or polishing. In these cases, it would be beneficial for the operator and for the tool to have the ability to easily tune the balance for the accessory combination and grinding/polishing application of his or her choice in the field.

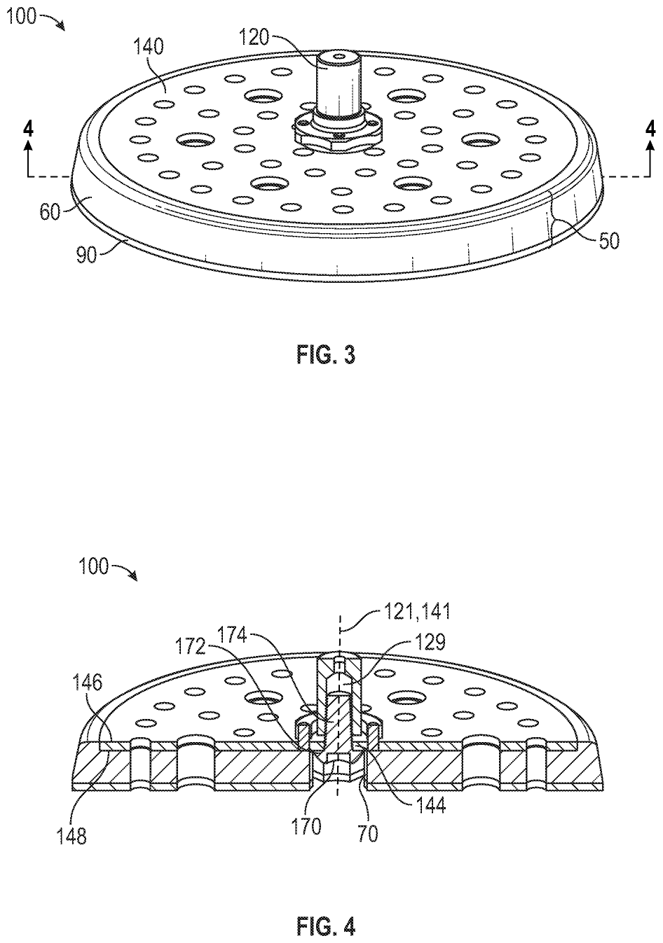

FIGS. 3 and 4 depict an accessory 50 and associated assembly 100 for attachment of the accessory to the random-orbital sander 10. As can be seen, the assembly 100 comprises a drive spindle 120. The drive spindle 120 is configured to be affixed to a rotary portion 14 of the random-orbital sander 10 (for example, by installation of the drive spindle into a recess in the rotary portion 14). The drive spindle comprises a tool end 124 and an accessory attachment end 128. The tool end 124 is adapted to be connected to, or is already affixed to, the driven portion of the random-orbital sander. The accessory attachment end 128 of the drive spindle 120 is adapted to connect to a support plate 140 of an accessory 50. Typically, the drive spindle 120 is pre-installed in the random-orbital sander 10 assembly and takes the place of a prior art spindle.

The support plate 140 of the accessory 50 is retained to the drive spindle by way of an attachment member 170. The attachment member 170 extends through an attachment aperture 144, which in turn extends through the support plate 140 from an accessory side 148 to a tool side 146. As can be seen in FIGS. 4 and 6, the compressible member 60 comprises an access aperture 70 through which the attachment member 170 passes. Because of this arrangement, the attachment member 170 can be made accessible from the side of the accessory 50 opposite the random-orbital sander (i.e., the open side that is easily visible and accessible to the operator).

The attachment member 170 comprises a retaining surface 172 and may comprise a retaining shaft 174. The retaining surface 172 may be provided as part of a flange configured to bear against the accessory side of the support plate. The retaining shaft, when provided, extends into a retention socket 129 on the drive spindle 120. In the embodiment shown, the attachment member 170 comprises a bolt or screw that is threaded into the drive spindle 120. As such, in this embodiment, the retaining shaft 174 is a threaded shaft, while the retention socket 129 is a threaded hole, and the retaining surface 172 is the head of the bolt or screw. In such configurations, a tool such as a wrench may be easily inserted into the access aperture 70 to tighten or loosen the attachment member as needed. Because the attachment member 170 is easily visible and accessible from the working side of the accessory 50, attachment and removal of the accessory to and from the random-orbital sander is made easier than in the prior art configurations shown in FIGS. 11-13.

While a threaded attachment is shown, other secure connections could be used within the scope of the present disclosure. For example, attachment between the attachment member 170 and the drive spindle 120 may be carried out by a quick-connect mechanism. A quick-connect mechanism may comprise, for example, a bayonet or other twist-lock cooperation. Linear or other non-rotating quick-connects may also be used, such as spring-loaded ball-and-socket connections or hex-shank quick connections.

By way of such assembly, the support plate 140 can be sandwiched between the drive spindle 120 and the attachment member 170, thereby retaining the accessory 50 to the drive spindle against axial movement along a longitudinal axis 121 of the drive spindle.

With only the axial retention means described above, the accessory may still be able to rotate relative to the drive spindle. To account for this, one or more drive members 160 and corresponding drive sockets 166 are provided to affix the drive spindle 120 and support plate 140 against relative rotational movement. The drive member(s) and drive socket(s) may be provided radially-outwardly of the longitudinal axis, or otherwise in a different radial location from the attachment member, in order to provide an anti-rotational grip on the support plate.

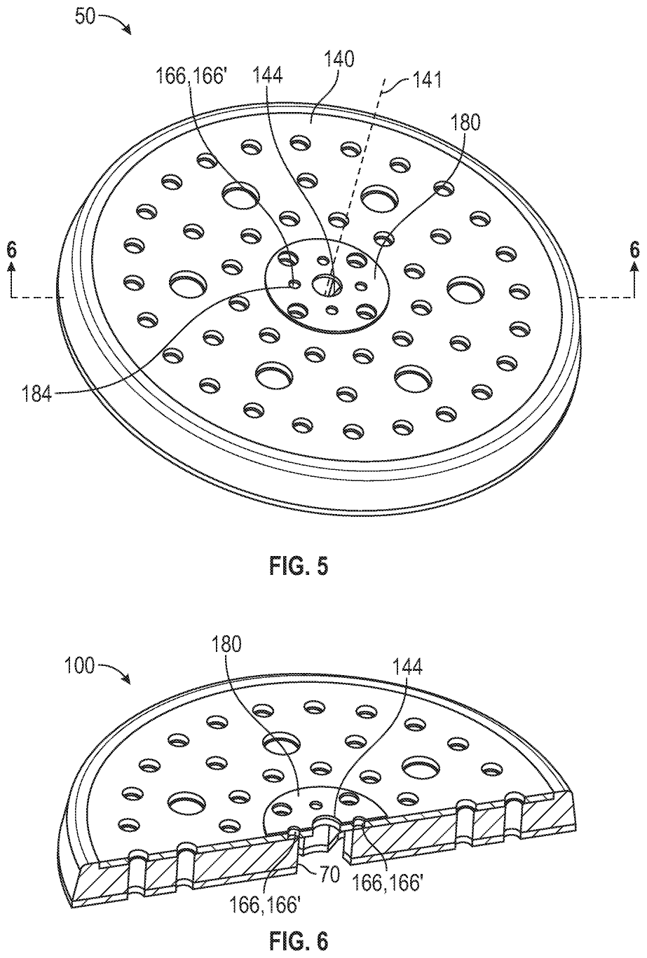

In the embodiment shown in FIGS. 3 and 4, four drive sockets 166 are distributed evenly around the attachment aperture 144, which is in turn aligned with an aperture axis 141. In this case, the drive sockets are provided in the form of holes 166′. As shown in FIGS. 5 and 6, a tuning member 180 is additionally provided on the support plate 140 and is configured with four tuning apertures 184 aligned with the drive sockets 166 on the support plate. When provided, the tuning member 180 can allow the accessory to be positioned a preset axial distance from the random-orbital sander to allow for optimum balancing of the rotating weight of the accessory in operation, thereby contributing to improved low-vibration performance. A tuning member 180 may be provided as an independent component from the support plate that can be assembled by the operator, may be a separately formed but affixed to the support plate 140 (for example, by adhesive, spin-welding, ultrasonic welding, or other means depending on the materials of the components and desired properties), or may integrally formed with the support plate 140.

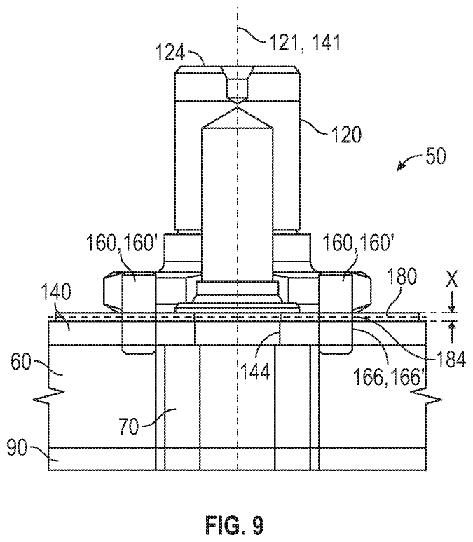

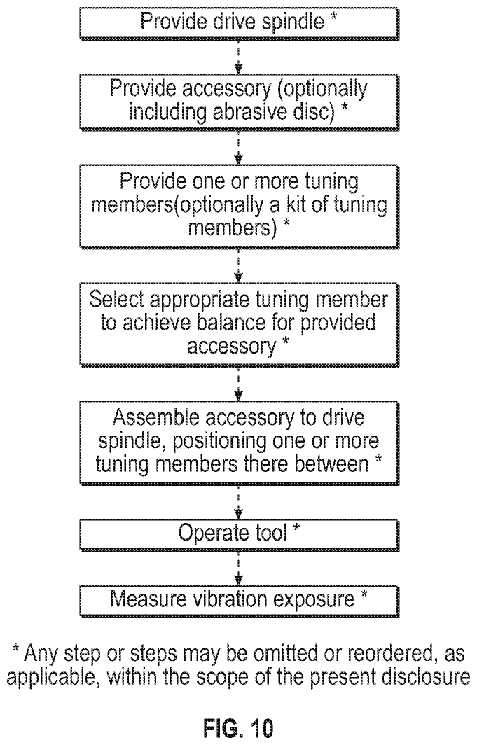

The tuning member 180 may be provided as a single member or as stack of two or more tuning members 180 having an additive height adapted to fine tune the balance of the rotating accessory. As can be seen in FIG. 9, a distance X is set between the drive spindle and the support plate, and a dashed line is shown in tuning member 180 to indicate the option of providing a stack of two or more tuning members 180. For example, a backup pad may be provided with a kit of tuning members 180, each having the same or different thicknesses, along with instructions for which combination of tuning members, or overall thickness of tuning members, should be installed for a particular combination of backup pad, abrasive disc, and/or force required by the application. In this manner, the operator can be guided to install an optimized combination of tuning members for his/ or her application of choice. Whether provided individually or in a stack, each tuning member may have a thickness T, by way of example only, of about 0.010 inches, about 0.030 inches, about 0.060 inches, or any other thickness that may achieve the beneficial balancing effects described herein. The present disclosure includes methods of providing such kits, for installing such tuning members (whether or not from such a kit), and for tuning the balance of an accessory on a ROS using one or more tuning member 180 (whether or not the one or more tuning members are provided in such a kit).

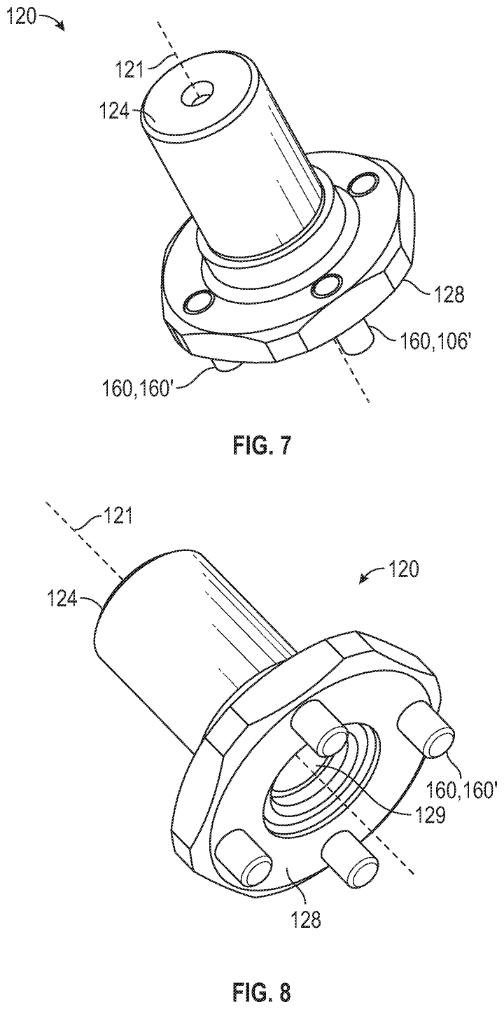

In the embodiments shown in FIGS. 7 and 8, a drive spindle 120 is provided with four drive members 160 extending from the accessory attachment end 128 of the drive spindle. In this case, the drive members are provided in the form of pins 160′. The drive members 160 as shown are distributed evenly around a retention socket 129, which in turn is aligned with a longitudinal axis 121 of the drive spindle 120.

As shown in a partially assembled state in the cross-sectional view of FIG. 9, the drive members 160 extend through the tuning apertures 184 on the optional tuning member 180 and also into the drive sockets 166 in the support plate.

In the embodiments of FIGS. 7-9, the drive members 160 comprise pins 160′ that are press fit into corresponding recesses in the accessory attachment end 128 of the drive spindle 120. The drive members 160 could also be secured to the drive spindle 120 by way of an adhesive, by welding, or by other known securing means. Drive members 160 may alternatively be unitary with the drive spindle (for example, formed by machining from a single piece). Although four drive members 160 are shown in the exemplary embodiment, it is also within the scope of the present disclosure to provide one, two, three, five, or more drive members, so long as they are configured to result in the functionality herein described.

It should be understood that, although the drive members 160 are shown in the exemplary embodiments as part of the drive spindle 120, they may additionally or alternatively be provided on the support plate and/or the optional tuning member 180. Similarly, drive sockets 166 may be provided additionally or alternatively on the drive spindle 120, so long as the drive members 160 interlock with the drive sockets 166 to affix the drive spindle 120 and support plate 140 against relative rotation. As one example, the drive spindle 120 and the support plate 140 may each be provided with two drive members 160 and two drive sockets 166.

While the drive member 160 and drive sockets 166 are shown in the depicted embodiments as pins 160′ and holes 166′ having a circular cross-section, other configurations are possible. The cross section of such components may be elliptical, triangular, rectangular, or any other shape, provided that the drive member(s) 160 interlock with the drive socket(s) 166 to retain the drive spindle 120 and the support plate 140 against relative rotation about the axes 121 and 141. The drive member(s) 160 and drive socket(s) 166 may alternatively be configured as interlocking teeth, which may be distributed, for example, in a circumferential manner about the axes 121 and 141. In such cases, each tooth extension would be a drive member 160, while each tooth recess would be a drive socket 166.

In order to allow for axial positioning of the accessory to be adjusted, the tuning aperture(s) 184 are adapted to cooperate with the drive member(s) 160 and drive socket(s) 166 such that retention of the support plate with respect to the drive spindle is maintained regardless of the spacing chosen for tuning. For example, each tuning aperture 184 permits a pass-through of a corresponding drive member 160 to its corresponding drive socket 166, and the drive member and drive socket are each of sufficient length and depth, respectively, such that retention can be maintained with different tuning member 184 thicknesses and/or with variable stack heights of tuning members. In this way, proper balance can be achieved for different circumstances without the need to make any alteration to either the drive spindle or the accessory.

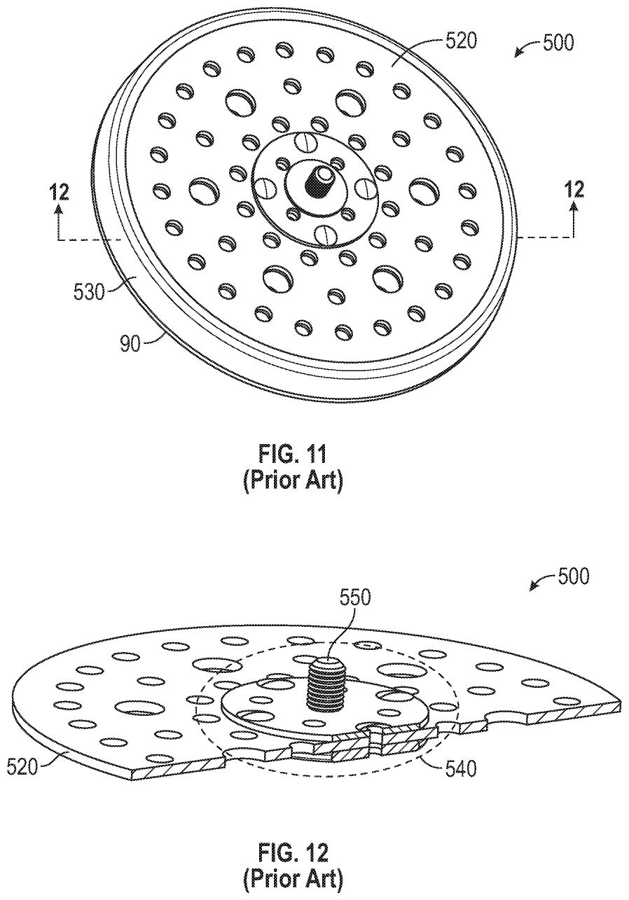

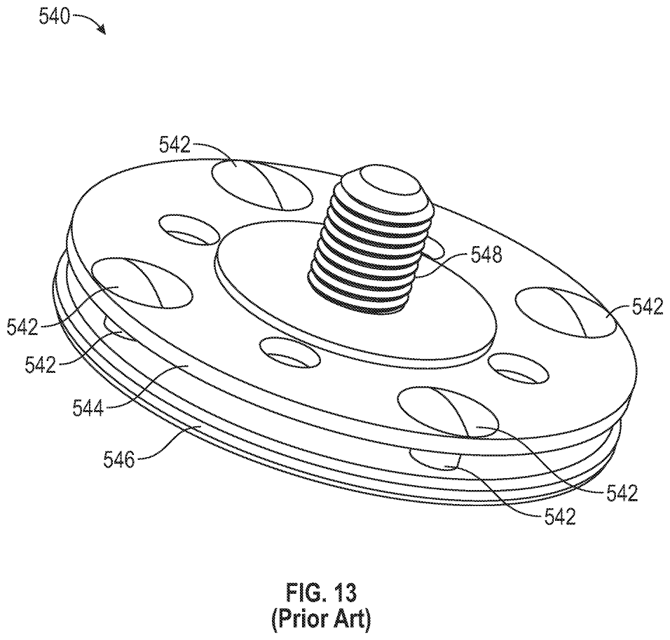

In contrast to the presently disclosed embodiments, a prior art accessory 500 and associated fastening hardware 540 is depicted in FIGS. 11-13. The prior art accessory 500 comprises a prior art support plate 520 and a prior art compressible member 530. As particularly detailed in FIG. 12, the prior art fastening hardware 540 includes a top plate 544 and a bottom plate 546 adapted to sit on either side of the prior art support plate 520. The top plate and bottom plate are rigidly affixed to one another by way of rivets 542 that pass through the prior art support plate. Moreover, a prior art threaded shaft 548 is provided affixed to the top plate 544. As such, each prior art accessory 500 includes its own prior art threaded shaft 548. The combination of all of this fastening hardware 540 results in the prior art accessory 500 being likely heavier and more costly to manufacture and sell, as well as more prone to imbalance, than the improved embodiments described herein.

For example, the inventor constructed a new cooperating drive spindle and BUP according to the present disclosure, and the BUP weight was reduced from approximately 130 grams (using prior fastening hardware ostensibly as shown in FIGS. 11-13) to approximately 90 grams, or a greater than 30 percent reduction in BUP weight. The prior art BUP was a Low Profile 861 Plus 6 inch diameter BUP, part number 204655, available from 3M Company, St. Paul, MN. The BUP according to the present disclosure used components akin to the prior art BUP, with the prior art fastening hardware replaced with an accessory attachment system as described herein. Due to the weight reduction and ability to tune the balance using a tuning member 180, an approximately 47 percent reduction in measured vibration exposure was further achieved. Vibration exposure was measured according to the ISO 28927 test method. The results are shown in Table 1 below.

TABLE 1

| | | Measured Vibration |
|---|---|---|
| BUP | BUP Weight (g) | Exposure (m/s²) |
| Prior art | 130 | 3.75 |
| New | 90 | 2.00 |

Moreover, due to the reduced weight of the new BUP, it was possible to replace the shaft balancer weight in the ROS, which was designed for a prior art 6 inch diameter BUP, with a smaller shaft balancer weight designed for use with a 5 inch diameter BUP. This also resulted in a weight reduction for the tool. The combined weight reduction of the tool and the BUP, in concert with reduced overall vibration, can result in a tool that is lighter overall and more comfortable for an operator to use.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. An assembly for attachment of an accessory to a random-orbital sander, the accessory having a mass, wherein the assembly comprises
a drive spindle comprising a longitudinal axis, a tool attachment end adapted for attaching the drive spindle to a rotary portion of the random-orbital sander, and an accessory attachment end for attaching the accessory to the drive spindle;
a support plate comprising an attachment aperture connecting a tool side and an accessory side, the attachment aperture comprising an aperture axis adapted to align with the longitudinal axis of the drive spindle;
one or more drive members located on and protruding from either of both of the drive spindle along the longitudinal axis and/or the support plate along the aperture axis;
one or more drive sockets corresponding to the one or more drive members, the one or more drive sockets located on and recessed within either or both of the drive spindle along the longitudinal axis and/or the support plate along the aperture axis;
one or more tuning members positioned between the accessory attachment end of the drive spindle and the tool side of the support plate to space the support plate from the drive spindle a predetermined distance X along the longitudinal axis, wherein the predetermined distance X is selected based on the mass of the accessory to establish proper axial spacing of the accessory from the random-orbital sander in order to fine tune vibration performance of the accessory; and
an attachment member adapted to protrude through the attachment aperture to retain the support plate to the accessory attachment end of the drive spindle with the one or more tuning members disposed therebetween;
wherein, upon assembly,
one the tool side of the support plate, one or more of the drive members seats within a corresponding drive socket to fix the drive spindle and support plate against relative rotational movement about the longitudinal axis; and
the attachment member protrudes through the attachment aperture from the accessory side of the support plate and is secured to the accessory attachment end of the drive spindle to fix the support plate and drive spindle against axial movement along the longitudinal axis.

2-4. (canceled)

5. The assembly of claim 1 wherein at least one drive member is integral with either the drive spindle or the support plate.

6. The assembly of claim 1 wherein at least one drive member is formed from a separate piece that is bonded to either the drive spindle or the support plate.

7. The assembly of claim 6 wherein the at least one drive member is bonded to either the drive spindle or the support plate by one of a friction fit, adhesive, thread, snap fit, or weld.

8. The assembly of claim 1 wherein the attachment member is adapted to threadably attach to the accessory attachment end of the drive spindle.

9. The assembly of claim 1 further comprising a compressible member attached to the accessory side of the support plate, the compressible member comprising an access aperture to permit access to the attachment member from the accessory side.

10. The assembly of claim 1 wherein the one or more tuning members comprises one or more tuning apertures corresponding to the one or more drive members, wherein the one or more drive members is adapted to pass through the one or more tuning apertures.

11. The assembly of claim 1 comprising two or more tuning members positioned in a stack between the accessory attachment end of the drive spindle and the tool side of the support plate.

12. An accessory for attachment to a random-orbital sander, the accessory having a mass, wherein the accessory comprises comprising
a support plate comprising an attachment aperture connecting a tool side and an accessory side, the attachment aperture comprising an aperture axis;
one or more
drive members protruding from the tool side of the support plate along the aperture axis; or
drive sockets recessed within the tool side of the support plate along the aperture axis;
wherein the one or more drive members and/or drive sockets are positioned radially outwardly of the aperture axis;
one or more tuning members adapted to be positioned on the tool side of the support plate, the one or more tuning members configured to establish proper axial spacing of the mass of the accessory from the random-orbital sander in order to fine tune vibration performance of the accessory; and
a compressible member attached to the accessory side of the support plate, the compressible member comprising an access aperture to permit access to the attachment aperture from the accessory side.

13. The accessory of claim 12 wherein the support plate comprises at least two drive sockets recessed within the tool side.

14. The accessory of claim 12 wherein the support plate comprises at least two drive members protruding from the tool side.

15. The accessory of claim 12 wherein the one or more tuning members comprises one or more tuning apertures corresponding to either of the one or more drive members or drive sockets, wherein the one or more drive members or drive sockets is aligned with the one or more tuning apertures.

16. The assembly of claim 12 comprising two or more tuning members positioned in a stack between the accessory attachment end of the drive spindle and the tool side of the support plate.

17. A drive spindle assembly for attachment of an accessory to a random-orbital sander, the accessory having a mass, wherein the drive spindle assembly comprises
a longitudinal axis, a tool attachment end adapted for attaching the drive spindle to a rotary portion of the random-orbital sander, and an accessory attachment end for attaching the accessory to the drive spindle;
one or more drive members protruding from the accessory attachment end of the drive spindle along the longitudinal axis; or
drive sockets recessed within the accessory attachment end of the drive spindle along the longitudinal axis;
wherein the one or more drive members and/or drive sockets are positioned radially outwardly of the longitudinal axis;
an attachment member adapted to retain the accessory to the accessory attachment end of the drive spindle; and
one or more tuning members adapted to be positioned on the accessory attachment end of the drive spindle, the one or more tuning members configured to establish proper axial spacing of the mass of the accessory from the random-orbital sander in order to fine tune vibration performance of the accessory.

18. The drive spindle assembly of claim 17 comprising at least two drive sockets recessed within the accessory attachment end.

19. The drive spindle assembly of claim 17 comprising at least two drive members protruding from the accessory attachment end.

20. The drive spindle assembly of claim 17 wherein the one or more tuning members comprises one or more tuning apertures corresponding to either of the one or more drive members or drive sockets, wherein the one or more drive members or drive sockets is aligned with the one or more tuning apertures.

21-25. (canceled)

26. A method of balancing vibration in a random orbital sander comprising
installing one or more tuning members between a drive spindle of the random orbital sander and a support plate of a cooperating accessory, the accessory having a mass;
the one or more tuning members having an overall thickness that results in a corresponding axial spacing X between the drive spindle and the support plate to establish proper axial spacing of the mass of the accessory from the random-orbital sander in order to fine tune vibration performance of the accessory, wherein the overall thickness of the one or more tuning members results in reduced measured vibration exposure in operation compared to an axial spacing of zero, wherein vibration exposure is measured according to the ISO 28972 test method;
wherein one of the drive spindle or the support plate comprises one more drive members, and the other of the drive spindle or the support plate comprises one or more corresponding drive sockets, and wherein the one or more tuning members comprises one or more tuning apertures corresponding to the one or more drive members such that the one or more drive members passes through the one or more tuning apertures to permit variable axial spacing between the drive spindle and the support plate.

27. The method of claim 26 wherein the reduction in measured vibration exposure is greater than 10 percent.

28. The method of claim 26, wherein the cooperating accessory is a backup pad without an abrasive disc installed thereon.
